(19) United States
(12) Patent Application Publication
(10) Pub. No.: US 2011/0093454 A1
(43) Pub. Date: Apr. 21, 2011

(54) SEARCH SYSTEM

(76) Inventor: YOSHIKAZU MUKAI, Tokyo (JP)

(21) Appl. No.: 12/891,917

(22) Filed: Sep. 28, 2010

(30) Foreign Application Priority Data
Oct. 15, 2009 (JP) 2009-237824

(51) Int. Cl. G06F 17/30

(52) U.S. Cl. 707/723; 707/E17.014

(57) ABSTRACT

A client device has a search request processing portion, an individual acquaintance table, and a personal relationship score reflection portion. The search request processing portion transmits a search request including a search condition to a search server device, and receives from the search server device a search result of searching for a person who meets the search condition. The individual acquaintance table stores an acquainted degree between persons calculated on the basis of a history of sending and receiving emails sent and received between the persons. The personal relationship score reflection portion assigns a score indicating an intensity of a personal relationship with a person who has inputted the search request to the person who has been searched out on the basis of the acquainted degree stored in the individual acquaintance table, and sorts the search result in descending order of the score.

### INCORPORATION BY REFERENCE

The present application claims priority from Japanese Patent Application No. 2009-237824, filed on Oct. 15, 2009 in Japan, the disclosure of which is incorporated herein by reference in its entirety.

### TECHNICAL FIELD

The present invention relates to search systems for searching for persons who meet a search condition.

### BACKGROUND ART

In carrying out business, or for better knowledge, there is sometimes a need to search for persons who have a desired knowledge and know-how. For such a purpose, a number of search systems have been proposed which are capable of searching for persons who meet a search condition among many.

For example, the accompanying Patent Document 1 describes a search system which lets a search requester input a search condition including an area of specialty and a knowledge level, searches a database having stored the area of specialty, the knowledge level, and the contact information for each individual person, and outputs a search result including the contact information of the persons who meet the search condition (referred to as the first related art hereinafter).

Further, the accompanying Patent Document 2 proposes a search system which lets a search requester input a search condition including a search keyword, searches a database having stored the title, contents, importance, characteristic words, writer, and the like for each individual article, and outputs as a search result the writers of the articles with a character string according with the search keyword included in the characteristic words and the like (referred to as the second related art hereinafter). Further, in the second related art, according to the importance, number, and the like of the articles searched out, a score is calculated for the persons searched out so as to display the persons who are sorted in descending order of the score.

[Patent Document 1] JP 4042445

[Patent Document 2] JP 2002-304536 A

Most of the people who utilize a search system to search for a person think of contacting the person searched out so as to acquire a new knowledge and know-how. For such search requesters, it is important who is easy to contact even more than how well the person searched out has the knowledge.

Hence, in the first related art described hereinabove, because only persons above a desired knowledge level are searched for, it is not knowable from a search result who is easy to contact for the searcher. Further, in the second related art described hereinabove, because persons are only displayed after arranged in descending order of a score calculated from the importance, number, and the like of the articles searched out, it is not clear from a search result who is easy to contact for the searcher.

### SUMMARY

In view of the above, an exemplary object of the present invention is to provide a search system, a search method, a client device, a search sever device, and a computer program for solving the problem that it is not knowable from a search result whether or not the person searched out is easy to contact for the search requester.

In order to achieve this exemplary object, an aspect in accordance with the present invention provides a search system composed of a client device and a search server device for searching for a person who meets a search condition included in a search request received from the client device, the search system including: a table for storing an acquainted degree between persons calculated on the basis of a history of sending and receiving emails sent and received between the persons; and a personal relationship score reflection unit for assigning a score indicating an intensity of a personal relationship with a person who has inputted the search request to the person who has been searched out on the basis of the acquainted degree stored in the table, and sorting a search result in descending order of the score.

Further, another aspect in accordance with the present invention provides a client device including: a search request processing unit transmitting a search request to a search server device, and receiving from the search server device a search result of searching for a person who meets a search condition included in the search request; a table for storing an acquainted degree between persons calculated on the basis of a history of sending and receiving emails sent and received between the persons; and a personal relationship score reflection unit for assigning a score indicating an intensity of a personal relationship with a person who has inputted the search request to the person who has been searched out on the basis of the acquainted degree stored in the table, and sorting the search result in descending order of the score.

Further, still another aspect in accordance with the present invention provides a search method executed by a computer having a plurality of individual acquaintance tables for storing an acquainted degree between a person and another person calculated on the basis of a history of sending and receiving emails sent and received between the person and the other person in correspondence with each person, the search method including the steps of: receiving a search request including information of a search requester and a search condition from a client device; creating a search result by searching for a person who meets the search condition; assigning a score indicating an intensity of a personal relationship with the search requester to the person included in the search result on the basis of the acquainted degree stored in the individual acquaintance table specified with the information of the search requester among the plurality of individual acquaintance tables, and sorting the search result in descending order of the score; and transmitting the search result to the client device.

Because the present invention is such configured as described hereinabove, a search requester becomes able to recognize who is easy to contact for himself/herself among the persons searched out from a search result.

### BRIEF DESCRIPTION OF THE DRAWINGS

FIG. 1 is a block diagram of a first exemplary embodiment of the present invention;

FIG. 2 shows an example of an individual acquaintance table;

FIG. 3 shows an example of employee information;

FIG. 4 is a flowchart showing a processing example of an acquaintance table extraction portion;

FIG. 5 shows an example of sending and receiving emails between employees by a mailing list;

FIG. 6 is a flowchart showing a processing example of searching in accordance with the first exemplary embodiment of the present invention;

FIG. 7 shows an example of a search result;

FIG. 8 is a block diagram of a second exemplary embodiment of the present invention;

FIG. 9 is a flowchart showing a processing example of searching in accordance with the second exemplary embodiment of the present invention;

FIG. 10 shows another example of the search result; and

FIG. 11 is a block diagram of a third exemplary embodiment of the present invention.

### EXEMPLARY EMBODIMENTS

### A First Exemplary Embodiment

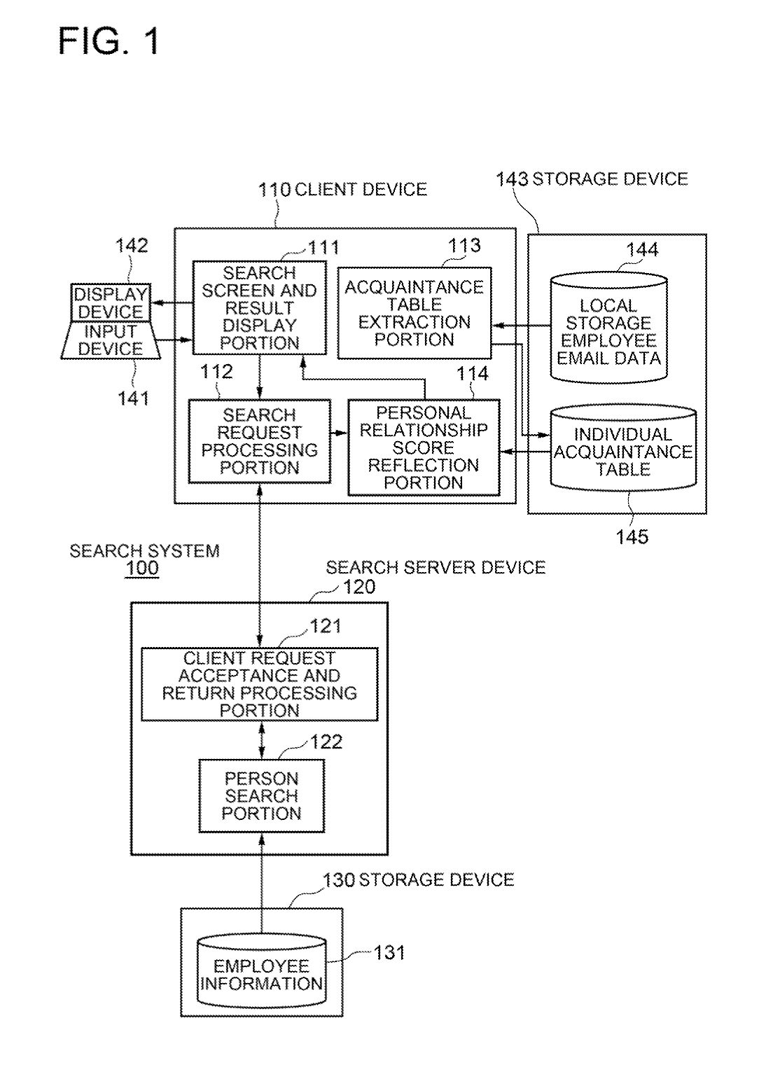

In reference to FIG. 1, a search system 100 in accordance with a first embodiment of the present invention is an in-company search system for employees of a particular company to search for persons who have a desired knowledge from the employees of their own company, and configured to include a client device 110, and a search server device 120 in connection with the client device 110 through a communication network such as an in-company network and the like.

The client device 110 is an information processing device utilized by the employees such as a personal computer assigned to each of the employees of the company. Herein, the client device 110 is supposed to be utilized by an employee U1. In FIG. 1, only one client device 110 is shown; however, if there are totally n employees U1 to Un, then there are n client devices corresponding to each of the employees in a one-for-one manner.

The client device 110 includes a search screen and result display portion 111, a search request processing portion 112, an acquaintance table extraction portion 113, and a personal relationship score reflection portion 114. Further, an input device 141 configured by a keyboard, a mouse, and the like, a display device 142 configured by a liquid crystal display and the like, and a storage device 143 configured by a hard disk device and the like are connected to the client device 110. Further, the storage device 143 stores a local storage employee email data 144 and an individual acquaintance table 145, which have such functions as described hereinbelow, respectively.

The local storage employee email data 144 is a history of sending and receiving emails (also simply referred to as mail) between the employee U1 and other employees. For example, when an email program is operated on the client device 110, the storage device 143 accumulates the history of sending and receiving emails with the email program utilized by the employee U1 as the local storage employee email data 144.

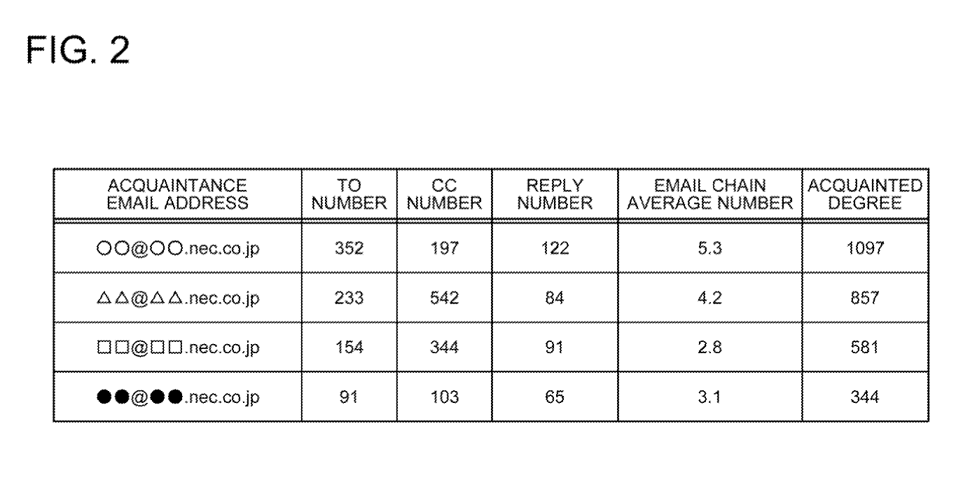

The individual acquaintance table 145 is a table for maintaining a score indicating an intensity of personal relationship between the employee U1 and other employees created on the basis of the local storage employee email data 144. In the first exemplary embodiment, an employee who has sent and received emails with the employee U1 is regarded as an employee whose relationship with the employee U1 is not zero (an acquaintance). FIG. 2 shows an example of the individual acquaintance table 145.

In reference to FIG. 2, the individual acquaintance table 145 is configured by the entry of each acquaintance of the employee U1, and each entry is composed of an acquaintance email address field, a To number field, a Cc number field, a Reply number field, an email chain average number field, and an acquainted degree field.

The acquaintance email address field records the email address of an acquaintance of the employee U1. The To number field records the total number of the emails sent and received with the email address of an acquaintance or the employee U1 set in the address To among the emails sent and received between the employee U1 and the acquaintance. The Cc number field records the total number of the emails sent and received with the email address of an acquaintance or the employee U1 set in the address Cc among the emails sent and received between the employee U1 and the acquaintance. The Reply number field records the total number of the reply emails sent and received between the employee U1 and an acquaintance. The email chain average number field records the email chain average number which, is an average repeat number of the case that the reply is repeated from a certain email between the employee U1 and an acquaintance. Finally, the acquainted degree field records the acquainted degree between the employee U1 and an acquaintance calculated from the above To number, Cc number, Reply number, and email chain average number.

Utilizing the To number, Cc number, Reply number, and email chain average number, various particular methods are conceivable for calculating the acquainted degree between the employee U1 and a certain acquaintance. For example, either the result of simply adding up those four numbers or the result of adding up the weighted four numbers may be regarded as the acquainted degree. In the case of weighting, it is desirable to weight the Cc number lighter than the To number. The reason is that the address Cc is utilized in such a manner as “to send it to you, too, just for your information”. Further, the email chain average number may also be applied as the weight for the Reply number. The following formula shows an example of calculating the acquainted degree. In addition, the present invention is not limited to the following calculation formula.

$$Acquainted degree = To number \times 1.0 ( the weight for To number ) + Cc number \times 0.5 ( the weight for Cc number ) + Reply number \times Email chain average number \qquad ( 1 )$$

In reference to FIG. 1 again, the acquaintance table extraction portion 113 of the client device 110 is a unit for creating the individual acquaintance table 145 on the basis of the local storage employee email data 144 stored in the storage device 143. This acquaintance table extraction portion 113 is periodically started up. Although the startup frequency can be any, considering that to create the individual acquaintance table 145 is a process which comparatively has a heavy load and takes a long time, and the calculation result does not change significantly in the case of a small number of newly added emails which have been sent and received, such a frequency is suitable as is started up once a week in the night.

The search screen and result display portion 111 is a unit for displaying a search screen accepting a search request designating a search condition, and a search result including the information of the employees who meet the search condition on the display device 142. The search screen and result display portion 111 transmits the search request accepted by the search screen to the search request processing portion 112, receives the search result in answer thereto from the personal relationship score reflection portion 114, and outputs it to the display device 142.

The search request processing portion 112 receives the search request from the search screen and result display portion 111, transmits it to the search server device 120, receives the search result in answer thereto from the search server device 120, and outputs it to the personal relationship score reflection portion 114. The search result received from the search server device 120 includes the email address of each employee who meets the search condition.

The personal relationship score reflection portion 114 receives the search result from the search request processing portion 112, assigns the value of the acquainted degree with the employee U1 recorded in the individual acquaintance table 145 to each of the employees included in the search result, and outputs the search result with the employees sorted in descending order of the assigned values of the acquainted degree to the search screen and result display portion 111.

On the other hand, the search server device 120 includes a client request acceptance and return processing portion 121 and a person search portion 122. Further, the search server device 120 is connected with a storage device 130 for storing employee information 131, which have such functions as described hereinbelow, respectively.

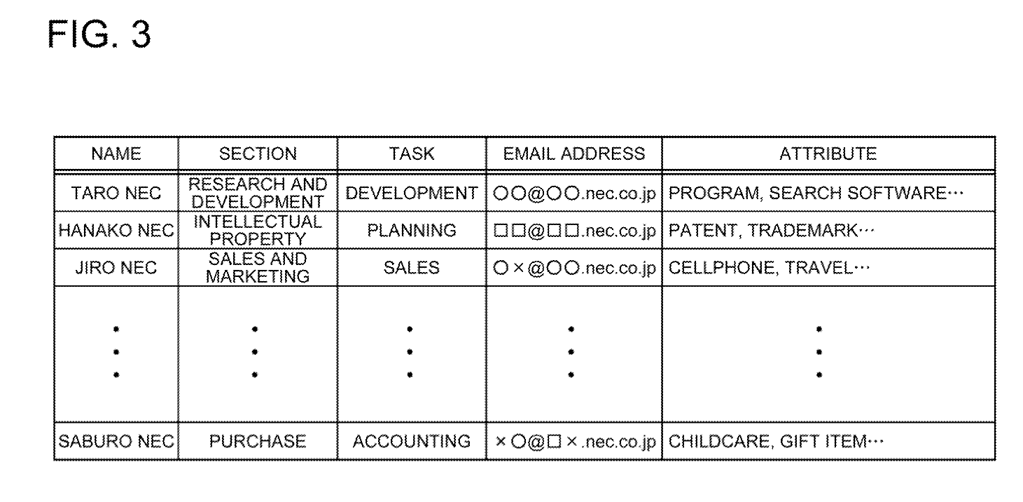

The employee information 131 records various kinds of information with respect to the employees of the company where the search system 100 is established. FIG. 3 shows an example of the employee information 131.

In reference to FIG. 3, the employee information 131 is configured by the entry of each employee, and each entry is composed of a name field, a section field, a task field, an email address field, and an attribute filed. The name field records the name of an employee. The section field and the task field record the section and the task of an employee, respectively. The email address field records the email address of an employee. The name, section, task, and email address are meta-information which characterizes an employee. Other information such as the telephone number may also be included in the meta-information. The attribute field records a character string or more which characterize(s) an employee with the area(s) of specialty and the details of business.

The employee information 131 as described hereinabove may either be the information prepared specially for searching for the employee or utilize the information prepared for other purposes (such as an in-company telephone directory system).

The client request acceptance and return processing portion 121 of the search server device 120 receives the search request from the search request processing portion 112 of the client device 110 and outputs it to the person search portion 122, and receives the search result from the person search portion 122 and returns it to the search request processing portion 112 of the client device 110.

The person search portion 122 receives the search request from the client request acceptance and return processing portion 121, searches the employee information 131 for the persons who meet the search condition designated by the search request, and outputs the search result to the client request acceptance and return processing portion 121.

Next, explanations will be made for a behavior of the first exemplary embodiment.

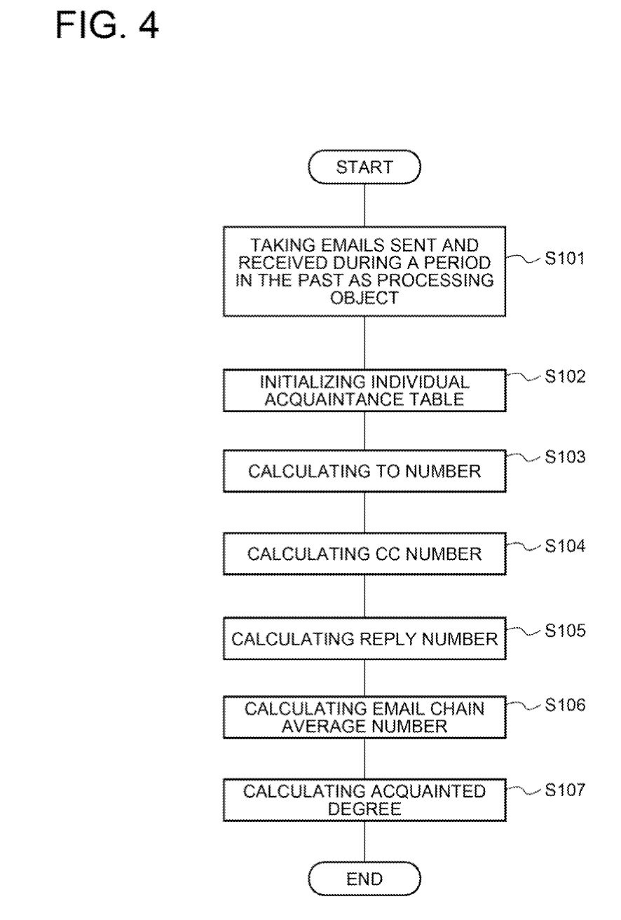

First, an explanation will be made in reference to the flowchart of FIG. 4 with respect to a process of creating the individual acquaintance table 145, which is periodically carried out.

When the acquaintance table extraction portion 113 of the client device 110 is started up, the process shown in FIG. 4 starts to be carried out. First, from the local storage employee email data 144, the acquaintance table extraction portion 113 extracts the emails sent and received during a predetermined period in the past from the sent/received time and date recorded in the email header to the present time and date (for example, over the past one year) as the processing object emails (step S101).

Next, the acquaintance table extraction portion 113 initializes the individual acquaintance table 145 to the initial state that nothing is recorded therein (step S102).

Next, the acquaintance table extraction portion 113 calculates the total number of the emails sent and received between the employee U1 and other employees with the address To in the processing object emails (step S103). In particular, the acquaintance table extraction portion 113 carries out the following process with respect to each of the processing object emails. In addition, the email address of the employee U1 is supposed to be preset in the acquaintance table extraction portion 113.

First, the acquaintance table extraction portion 113 determines whether the email is sent or received.

In the case of a sent email, the acquaintance table extraction portion 113 confirms the email address recorded in the address To of the email header, and then repeatedly carries out the following process with each of the confirmed email addresses the domain of which accords with the company email address domain. First, it searches the individual acquaintance table 145 for the entry having the email address in the acquaintance email address field. If the corresponding entry does not exist, then the acquaintance table extraction portion 113 adds to the individual acquaintance table 145 an entry which sets the email address into the acquaintance email address field and the value 0 into the To number field, the Cc number field, the Reply number filed, the email chain average number field, and the acquainted degree field respectively, and increases the value of the To number field of the entry by 1. If the corresponding entry exists, then the acquaintance table extraction portion 113 just increases the value of the To number field of the entry by 1.

On the other hand, in the case of a received email, the acquaintance table extraction portion 113 determines whether or not the email address recorded in the address To of the email header is the email address of the employee U1; if not, it ends the process with respect to the email. If the email address of the employee U1 is set in the address To, then the acquaintance table extraction portion 113 confirms the email address recorded in From. If the domain of the confirmed email address accords with the company email address domain, it searches the individual acquaintance table 145 for the entry having the email address in the acquaintance email address field. If the corresponding entry does not exist, then the acquaintance table extraction portion 113 adds to the individual acquaintance table 145 an entry which sets the email address into the acquaintance email address field and the value 0 into the To number field, the Cc number field, the Reply number filed, the email chain average number field, and the acquainted degree field respectively, and increases the value of the To number field of the entry by 1. If the corresponding entry exists, then the acquaintance table extraction portion 113 just increases the value of the To number field of the entry by 1.

Next, the acquaintance table extraction portion 113 calculates the total number of the emails sent and received between the employee U1 and other employees with the address Cc in the processing object emails (step S104). In particular, the acquaintance table extraction portion 113 carries out the following process with respect to each of the processing object emails.

First, the acquaintance table extraction portion 113 determines whether the email is sent or received.

In the case of a sent email, the acquaintance table extraction portion 113 confirms the email address recorded in the address Cc of the email header, and then repeatedly carries out the following process with each of the confirmed email addresses the domain of which accords with the company email address domain. First, it searches the individual acquaintance table 145 for the entry having the email address in the acquaintance email address field. If the corresponding entry does not exist, then the acquaintance table extraction portion 113 adds to the individual acquaintance table 145 an entry which sets the email address into the acquaintance email address field and the value 0 into the To number field, the Cc number field, the Reply number filed, the email chain average number field, and the acquainted degree field respectively, and increases the value of the Cc number field of the entry by 1. If the corresponding entry exists, then the acquaintance table extraction portion 113 just increases the value of the Cc number field of the entry by 1.

On the other hand, in the case of a received email, the acquaintance table extraction portion 113 determines whether or not the email address recorded in the address Cc of the email header is the email address of the employee U1; if not, it ends the process with respect to the email. If the email address of the employee U1 is set in the address Cc, then the acquaintance table extraction portion 113 confirms the email address recorded in From. If the domain of the confirmed email address accords with the company email address domain, it searches the individual acquaintance table 145 for the entry having the email address in the acquaintance email address field. If the corresponding entry does not exist, then the acquaintance table extraction portion 113 adds to the individual acquaintance table 145 an entry which sets the email address into the acquaintance email address field and the value 0 into the To number field, the Cc number field, the Reply number filed, the email chain average number field, and the acquainted degree field respectively, and increases the value of the Cc number field of the entry by 1. If the corresponding entry exists, then the acquaintance table extraction portion 113 just increases the value of the Cc number field of the entry by 1.

Next, the acquaintance table extraction portion 113 calculates the Reply number which is the total number of the emails sent and received as reply to emails from the employee U1 and others (step S105). In particular, it carries out such a process as described hereinbelow.

First, the acquaintance table extraction portion 113 classifies the processing object emails into single emails and groups of related emails.

A single email refers to an email which is neither a reply email nor an email as a reply object. If an email in the history does not include In-Reply-To in the email header, and there are no other emails in the history which have the message ID of that email in their In-Reply-To, then the acquaintance table extraction portion 113 determines the email as a single email.

A group of related emails refers to a plurality of emails which are started to relate each other through reply from a certain email. For example, when 3 emails are sent and received in such a manner as: the employee U1→(an email 1)→the employee U2→(an email 2)→the employee U1→(an email 3)→the employee U2, the emails 1 and 3 are recorded in the sent history while the email 2 is recorded in the received history for the employee U1. In this case, In-Reply-To is not included in the email header of the email 1, the Message ID of the email 1 is set in the In-Reply-To of the email header of the email 2, and the Message ID of the email 2 is set in the In-Reply-To of the email header of the email 3. By virtue of the Message ID set in the In-Reply-To, the acquaintance table extraction portion 113 extracts a series of emails related with each other through reply as described hereinabove as a group of related emails.

Next, the acquaintance table extraction portion 113 carries out the following process with respect to each group of related emails.

First, the acquaintance table extraction portion 113 sums up the number of the emails in reply to emails of the employee U1 and another person for the group of related emails. For example, when the group of related emails has 3 emails sent and received in such a manner as: the employee U1→(an email 1)→the employee U2→(an email 2)→the employee U1→(an email 3)→the employee U2, the number of the reply emails is counted as 2 (the first email is not a reply email).

Next, the acquaintance table extraction portion 113 repeatedly carries out the following process with each of the email addresses the domain of which accords with the company email address domain, among the email addresses set in any of the To, Cc, and From of the email headers of the group of related emails (however, the email address of the user of the subject client device is excluded). That is, it searches the individual acquaintance table 145 for the entry having the email address in the acquaintance email address field, and increases the value of the Reply number field of the entry searched out by the number of the reply emails summed up for the group of related emails.

Next, the acquaintance table extraction portion 113 calculates the email chain average number (step S106). In particular, it carries out the following process.

For each entry of the individual acquaintance table 145, the acquaintance table extraction portion 113 calculates the summation of the total number of the single emails which include the acquaintance email address of the entry in To, Cc, and From and the total number of the groups of related emails which include the acquaintance email address of the entry in To, Cc, and From, and then sets the value of the Reply number of the entry divided by the summation into the email chain average number field of the entry. For example, if the employees U1 and U2 have exchanged 5 single emails in total and 15 groups of related emails in total, and if the Reply number is 60 between the employees U1 and U2, then the email chain average number for the employee U2 in the individual acquaintance table 145 of the employee U1 is: 60/(5+15)=3.

Herein, the email chain average number was calculated not only with the groups of related emails but also with the single emails, regarding the reply number of the single emails as 0. However, as another exemplary embodiment, the average number of the reply emails per group of related emails may also be regarded as the email chain average number, regardless of the single emails. Thus, in the example of the employees U1 and U2 described hereinabove, the email chain average number for the employee U2 in the individual acquaintance table 145 of the employee U1 is: 60/15=4.

Finally, for each entry of the individual acquaintance table 145, based on the values set respectively in the To number field, the Cc number field, the Reply number filed, and the email chain average number field of the entry, the acquaintance table extraction portion 113 utilizes the formula (1) described hereinbefore, for example, to calculate the acquainted degree and set it into the acquainted degree field (step S107).

In the above explanation for the acquaintance table extraction portion 113, regardless of whether or not each email included in the processing object emails is an email sent or received through a mailing list, the emails sent and received through a mailing list are treated in the same manner as ordinary emails sent and received in calculating the To number, the Cc number, the Reply number, and the email chain average number. However, as another exemplary embodiment of the present invention, the To number, the Cc number, the Reply number, and the email chain average number may also be calculated by determining whether or not each email included in the processing object emails is an email sent or received through a mailing list so as to distinguish it from an ordinary email sent or received.

The acquaintance table extraction portion 113 confirms whether or not the email address set in To or Cc is the mailing list address utilized in the company so as to determine whether or not a email is sent through the mailing list, and confirms whether or not the email address set in Reply-to of the email header is the mailing list address utilized in the company so as to determine whether or not a email is received through the mailing list. The mailing list address utilized in the company and the email addresses of the corresponding members are maintained in an in-company mail server. The acquaintance table extraction portion 113 obtains the mailing list address and the email addresses of the corresponding members from the in-company mail server and keeps them for the use in determination.

Hereinbelow, explanations will be made with respect to methods of calculating the To number, the Cc number, the Reply number, and the email chain average number in consideration of whether or not the email is sent or received through a mailing list.

When the To number, the Cc number, the Reply number, and the email chain average number are calculated for the emails sent and received through a mailing list, there are three calculation methods as described hereinbelow. Because each of the methods has a merit and a demerit, it is desirable to be able to select which method to utilize through the system configuration information.

(1) The First Method

For the emails by the mailing list, the To number, the Cc number, the Reply number, and the email chain average number are not counted.

(2) The Second Method

For all the members of the mailing list, the To number, the Cc number, the Reply number, and the email chain average number are counted.

(3) The Third Method

For only the employees who have later replied to the emails by the mailing list among the members of the mailing list, the To number, the Cc number, the Reply number, and the email chain average number are counted.

First, the first method will be explained.

(1-1) To Number

The acquaintance table extraction portion 113 inputs emails one by one from the processing object emails, and determines whether the inputted email is a sent email or a received email.

In the case of a sent email, the acquaintance table extraction portion 113 confirms the email address recorded in the address To of the email header. If the confirmed email address is the mailing list address, the process for the email is ended; if it is not the mailing list address but of an ordinary sent email, the same process is carried out as has been explained for a sent email in the step S103 of FIG. 4.

In the case of a received email, if the email address set in Reply-to of the email header is the mailing list address, the acquaintance table extraction portion 113 ends the process for the email; if it is not the mailing list address but of an ordinary received email, the same process is carried out as has been explained for a received email in the step S103 of FIG. 4.

(1-2) The Cc Number

The acquaintance table extraction portion 113 inputs emails one by one from the processing object emails, and determines whether the inputted email is a sent email or a received email.

In the case of a sent email, the acquaintance table extraction portion 113 confirms the email address recorded in the address Cc of the email header. If the confirmed email address is the mailing list address, the process for the email is ended; if it is not the mailing list address but of an ordinary sent email, the same process is carried out as has been explained for a sent email in the step S104 of FIG. 4.

In the case of a received email, if the email address set in Reply-to of the email header is the mailing list address, the acquaintance table extraction portion 113 ends the process for the email; if it is not the mailing list address but of an ordinary received email, the same process is carried out as has been explained for a received email in the step S104 of FIG. 4.

(1-3) The Reply Number

The acquaintance table extraction portion 113 carries out the same process as has been described in the step S105 of FIG. 4, classifying the processing object emails into single emails and groups of related emails. Next, the acquaintance table extraction portion 113 carries out the following process for each group of related emails.

First, the acquaintance table extraction portion 113 determines whether or not the group of related emails includes emails addressed to the mailing list address. If it does, the process is ended for the group of related emails. If it does not, the same process is carried out as has been explained for a group of related emails in the step S105 of FIG. 4.

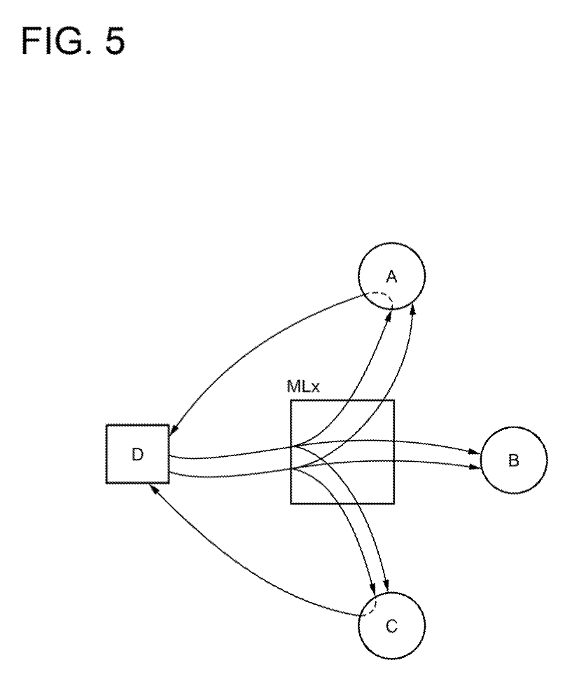

For example, as shown in FIG. 5, it is assumed that there are members A, B, and C on a mailing list X (MLx), a nonmember D sends an email to MLx, the member A sends a reply to D, D sends a reply to MLx, and the member C sends a reply to D. That is, such a case of exchanging emails is considered as: D→MLx (A)→D→MLx (C)→D. In this case, in making up the individual acquaintance table of D, totally 4 emails are extracted as a group of related emails: the email sent by D to MLx, the email sent by A to D in reply thereto, the email sent by D to MLx in reply thereto, and the email sent by C to D in reply thereto. In processing this group of related emails, the acquaintance table extraction portion 113 confirms that it includes emails by the mailing list, and thereby does not add the Reply number based on this group of related emails to the individual acquaintance table of D.

(1-4) The Email Chain Average Number

The acquaintance table extraction portion 113 excludes the single emails by the mailing list and the groups of related emails including emails by the mailing list; for each entry of the individual acquaintance table 145, it calculates the summation of the total number of the single emails which include the acquaintance email address of the entry in To, Cc, and From and the total number of the groups of related emails which include the acquaintance email address of the entry in To, Cc, or From, and then sets the value of the Reply number of the entry divided by the summation into the email chain average number field of the entry.

Next, the second method will be explained.

(2-1) To Number

The acquaintance table extraction portion 113 inputs emails one by one from the processing object emails, and determines whether the inputted email is a sent email or a received email.

In the case of a sent email, the acquaintance table extraction portion 113 confirms the email address recorded in the address To of the email header. If the confirmed email address is the mailing list address, it confirms the member list corresponding to the mailing list address and carries out the following process for each member on the list. First, the acquaintance table extraction portion 113 searches the individual acquaintance table 145 for the entry having the email address of the member in the acquaintance email address field. If the corresponding entry does not exist, then it adds to the individual acquaintance table 145 an entry which sets the email address into the acquaintance email address field and the value 0 into the To number field, the Cc number field, the Reply number filed, the email chain average number field, and the acquainted degree field respectively, and increases the value of the To number field of the entry by 1. If the corresponding entry exists, then the acquaintance table extraction portion 113 just increases the value of the To number field of the entry by 1. On the other hand, if the email address recorded in the address To is not the mailing list address, the same process is carried out as has been explained for a sent email in the step S103 of FIG. 4.

In the case of a received email, no matter whether or not the email is by the mailing list, the acquaintance table extraction portion 113 carries out the same process as has been explained for a received email in the step S103 of FIG. 4.

(2-2) Cc Number

The acquaintance table extraction portion 113 inputs emails one by one from the processing object emails, and determines whether the inputted email is a sent email or a received email.

In the case of a sent email, the acquaintance table extraction portion 113 confirms the email address recorded in the address Cc of the email header. If the confirmed email address is the mailing list address, it confirms the member list corresponding to the mailing list address and carries out the following process for each member on the list. First, the acquaintance table extraction portion 113 searches the individual acquaintance table 145 for the entry having the email address of the member in the acquaintance email address field. If the corresponding entry does not exist, then it adds to the individual acquaintance table 145 an entry which sets the email address into the acquaintance email address field and the value 0 into the To number field, the Cc number field, the Reply number filed, the email chain average number field, and the acquainted degree field respectively, and increases the value of the Cc number field of the entry by 1. If the corresponding entry exists, then the acquaintance table extraction portion 113 just increases the value of the Cc number field of the entry by 1. On the other hand, if the email address recorded in the address Cc is not the mailing list address, the same process is carried out as has been explained for a sent email in the step S104 of FIG. 4.

In the case of a received email, no matter whether or not the email is by the mailing list, the acquaintance table extraction portion 113 carries out the same process as has been explained for a received email in the step S104 of FIG. 4.

(2-3) Reply Number

No matter whether or not the inputted emails include those addressed to the mailing list address, the acquaintance table extraction portion 113 carries out the same process as has been described in the step S105 of FIG. 4. For instance, in the case of the example shown in FIG. 5, the acquaintance table extraction portion 113 counts the Reply number=3 for all the members (A, B, and C) in the individual acquaintance table of D.

(2-4) Email Chain Average Number

No matter whether or not the inputted emails include those addressed to the mailing list address, the acquaintance table extraction portion 113 carries out the same process as has been described in the step S106 of FIG. 4.

Next, the third method will be explained.

(3-1) To Number

The acquaintance table extraction portion 113 inputs emails one by one from the processing object emails, and determines whether the inputted email is a sent email or a received email.

In the case of a sent email, the acquaintance table extraction portion 113 confirms the email address recorded in the address To of the email header. If the confirmed email address is the mailing list address, it carries out the following process. First, the acquaintance table extraction portion 113 confirms the member list corresponding to the mailing list address. Then, it identifies those who have later replied among the members on the list. Whether a particular email has been replied to or not is determined by checking whether or not there is a history of other emails with the same Message ID set in In-Reply-To of the email header as the Message ID set in the email header of the particular email. Then, the following process is carried out for each of the identified members only. First, the acquaintance table extraction portion 113 searches the individual acquaintance table 145 for the entry having the email address of the member in the acquaintance email address field. If the corresponding entry does not exist, then it adds to the individual acquaintance table 145 an entry which sets the email address into the acquaintance email address field and the value 0 into the To number field, the Cc number field, the Reply number filed, the email chain average number field, and the acquainted degree field respectively, and increases the value of the To number field of the entry by 1. If the corresponding entry exists, then the acquaintance table extraction portion 113 just increases the value of the To number field of the entry by 1.

On the other hand, for a sent email the email address of which recorded in the address To is not the mailing list address, without confirming whether or not there is a reply to the sent email, the acquaintance table extraction portion 113 carries out the same process as has been explained for a sent email in the step S103 of FIG. 4.

In the case of a received email, the acquaintance table extraction portion 113 confirms whether or not the email address set in Reply-to of the email header is the mailing list address; if it is, the following process is carried out. First, the acquaintance table extraction portion 113 confirms whether or not the received email has been later replied to. Whether a particular email has been replied to or not is determined by checking whether or not there is a history of other emails with the same Message ID set in In-Reply-To of the email header as the Message ID set in the email header of the particular email. Then, if the received email has not been replied to, the process is ended for the received email. On the other hand, if the received email has been replied to, the same process is carried out as has been explained for a received email in the step S103 of FIG. 4.

On the other hand, for a received email the email address of which set in Reply-to is not the mailing list address, without confirming whether or not there is a reply to the received email, the acquaintance table extraction portion 113 carries out the same process as has been explained for a received email in the step S103 of FIG. 4.

(3-2) Cc Number

The acquaintance table extraction portion 113 inputs emails one by one from the processing object emails, and determines whether the inputted email is a sent email or a received email.

In the case of a sent email, the acquaintance table extraction portion 113 confirms the email address recorded in the address Cc of the email header. If the confirmed email address is the mailing list address, it carries out the following process. First, the acquaintance table extraction portion 113 confirms the member list corresponding to the mailing list address. Then, it identifies those who have later replied among the members on the list. Whether a particular email has been replied to or not is determined by checking whether or not there is a history of other emails with the same Message ID set in In-Reply-To of the email header as the Message ID set in the email header of the particular email. Then, the following process is carried out for each of the identified members only. First, the acquaintance table extraction portion 113 searches the individual acquaintance table 145 for the entry having the email address of the member in the acquaintance email address field. If the corresponding entry does not exist, then it adds to the individual acquaintance table 145 an entry which sets the email address into the acquaintance email address field and the value 0 into the To number field, the Cc number field, the Reply number filed, the email chain average number field, and the acquainted degree field respectively, and increases the value of the Cc number field of the entry by 1. If the corresponding entry exists, then the acquaintance table extraction portion 113 just increases the value of the Cc number field of the entry by 1.

On the other hand, for a sent email the email address of which recorded in the address Cc is not the mailing list address, without confirming whether or not there is a reply to the sent email, the acquaintance table extraction portion 113 carries out the same process as has been explained for a sent email in the step S104 of FIG. 4.

In the case of a received email, the acquaintance table extraction portion 113 confirms whether or not the email address set in Reply-to of the email header is the mailing list address; if it is, the following process is carried out. First, the acquaintance table extraction portion 113 confirms whether or not the received email has been later replied to. Whether a particular email has been replied to or not is determined by checking whether or not there is a history of other emails with the same Message ID set in In-Reply-To of the email header as the Message ID set in the email header of the particular email. Then, if the received email has not been replied to, the process is ended for the received email. On the other hand, if the received email has been replied to, the same process is carried out as has been explained for a received email in the step S104 of FIG. 4.

On the other hand, for a received email the email address of which set in Reply-to is not the mailing list address, without confirming whether or not there is a reply to the received email, the acquaintance table extraction portion 113 carries out the same process as has been explained for a received email in the step S104 of FIG. 4.

(3-3) Reply Number

The acquaintance table extraction portion 113 carries out the same process as has been explained in the step S105 of FIG. 4, classifying the processing object emails into single emails and groups of related emails. Next, the acquaintance table extraction portion 113 carries out the following process for each group of related emails.

First, the acquaintance table extraction portion 113 determines whether or not the group of related emails includes emails addressed to the mailing list address. If it does, the following process is carried out. First, the acquaintance table extraction portion 113 identifies the members who have later replied to the emails sent and received through the mailing list address included in the group of related emails. Whether a particular email has been replied to or not is determined by checking whether or not there is a history of other emails with the same Message ID set in In-Reply-To of the email header as the Message ID set in the email header of the particular email. Then, the Reply number by the group of related emails is counted for the identified members only. For instance, in the case of the example shown in FIG. 5, the acquaintance table extraction portion 113 adds the Reply number=3 only for the members A and C who have later replied to the individual acquaintance table of D.

On the other hand, for a group of related emails which does not include emails addressed to the mailing list, the same process is carried out as has been explained for a group of related emails in the step S105 of FIG. 4.

(3-4) Email Chain Average Number

For each entry of the individual acquaintance table 145, the acquaintance table extraction portion 113 carries out the following process.

First, for each single email which includes the acquaintance email address of the entry in To, Cc, or From, the acquaintance table extraction portion 113 determines whether or not it is an email by the mailing list, and confirms whether or not it has been later replied to for the email by the mailing list. Then, among the single emails which include the acquaintance email address of the entry in To, Cc, or From, it records the summation of the total number of the emails not by the mailing list and the total number of emails by the mailing list which have been later replied to as the total number of the single emails.

Further, for each group of related emails which includes the acquaintance email address of the entry in To, Cc, or From, the acquaintance table extraction portion 113 determines whether or not it includes emails by the mailing list, and confirms whether or not it has been later replied to for the group of related emails including emails by the mailing list. Then, among the groups of related emails which include the acquaintance email address of the entry in To, Cc, or From, it records the summation of the total number of the groups of related emails not including emails by the mailing list and the total number of the groups of related emails including emails by the mailing list which have been later replied to as the total number of the groups of related emails.

Then, the acquaintance table extraction portion 113 sets the value of dividing the Reply number of the entry by the summation of the total number of the single emails and the total number of the groups of related emails recorded hereinabove into the email chain average number filed of the entry.

Subsequently, explanations will be made for a behavior at the time that the employee U1 of the client device 110 has inputted a search request designating a search condition in the first exemplary embodiment.

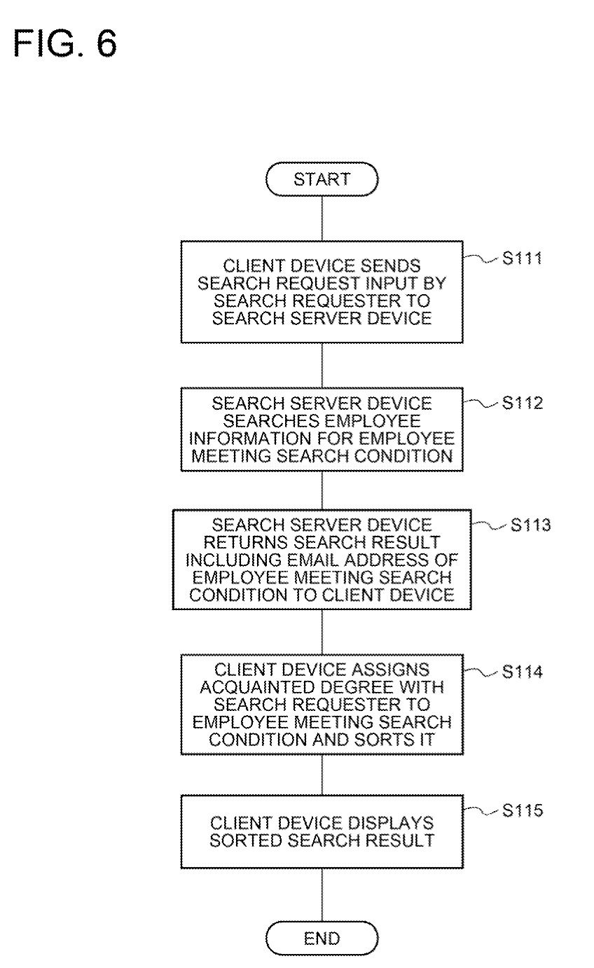

When a search request is inputted which designating a search keyword as the search condition through the search screen which is displayed on the display device 142 by utilizing the search screen and result display portion 111, the client device 110 utilizes the search request processing portion 112 to transmit the search request to the search server device 120 (step S111 of FIG. 6).

On receiving the search request from the client device 110 by utilizing the client request acceptance and return processing portion 121, the search server device 120 utilizes the person search portion 122 to search the employee information 131 for employees who have a character string according with the search keyword designated by the search request as the search condition in the attribute information (step S112). Then, the search server device 120 utilizes the client request acceptance and return processing portion 121 to return the search result to the client device 110 (step S113). The search result includes the meta-information including the email address of the employees searched out.

On receiving the search result from the search server device 120 by utilizing the search request processing portion 112, the client device 110 utilizes the personal relationship score reflection portion 114 to reflect a personal relationship score to the search result (step S114). In particular, the personal relationship score reflection portion 114 carries out the following process for each employee included in the search result. First, it searches the individual acquaintance table 145 for the entry which has the email address of the employee in the acquaintance email address filed. When the search is successful, it assigns the acquainted degree set in the acquainted degree field of the entry searched out to the employee as the score indicating an intensity of personal relationship with the search requester. If the search is unsuccessful, it excludes the information of the employee from the search result. Next, the personal relationship score reflection portion 114 sorts the employees in the search result in descending order of the assigned scores, and transmits the sorted search result to the search screen and result display portion 111.

Next, the client device 110 utilizes the search screen and result display portion 111 to display the search result on the display device 142 (step S115).

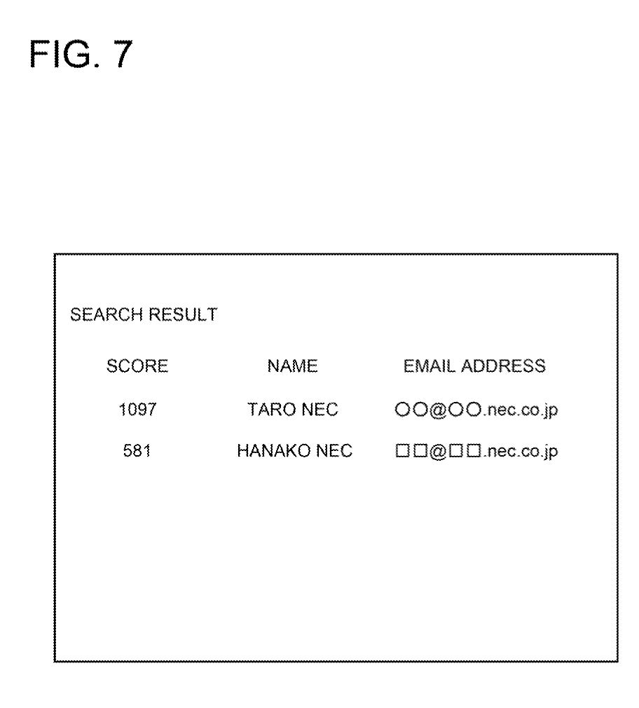

FIG. 7 shows an example of the search result displayed on the display device 142. As shown in FIG. 7, in the first exemplary embodiment, the information of the employees who meet the search condition is displayed in descending order of the scores. In the example, as the information of the employees, the score, the name, and the email address are utilized. However, other information such as the telephone number and the like may also be displayed, or the score may also be omitted from the display.

In this manner, according to the first exemplary embodiment, because the employees who meet the search condition are displayed in descending order of the scores indicating an intensity of personal relationship with the search requester, it is possible for the search requester to instantly recognize from the search result who is easy to contact among the persons searched out.

Further, according to the first exemplary embodiment, because the client device 110 is configured to include the acquaintance table extraction portion 113 and the personal relationship score reflection portion 114, it is not necessary at all to reconfigure the search server device 120.

### A Second Exemplary Embodiment

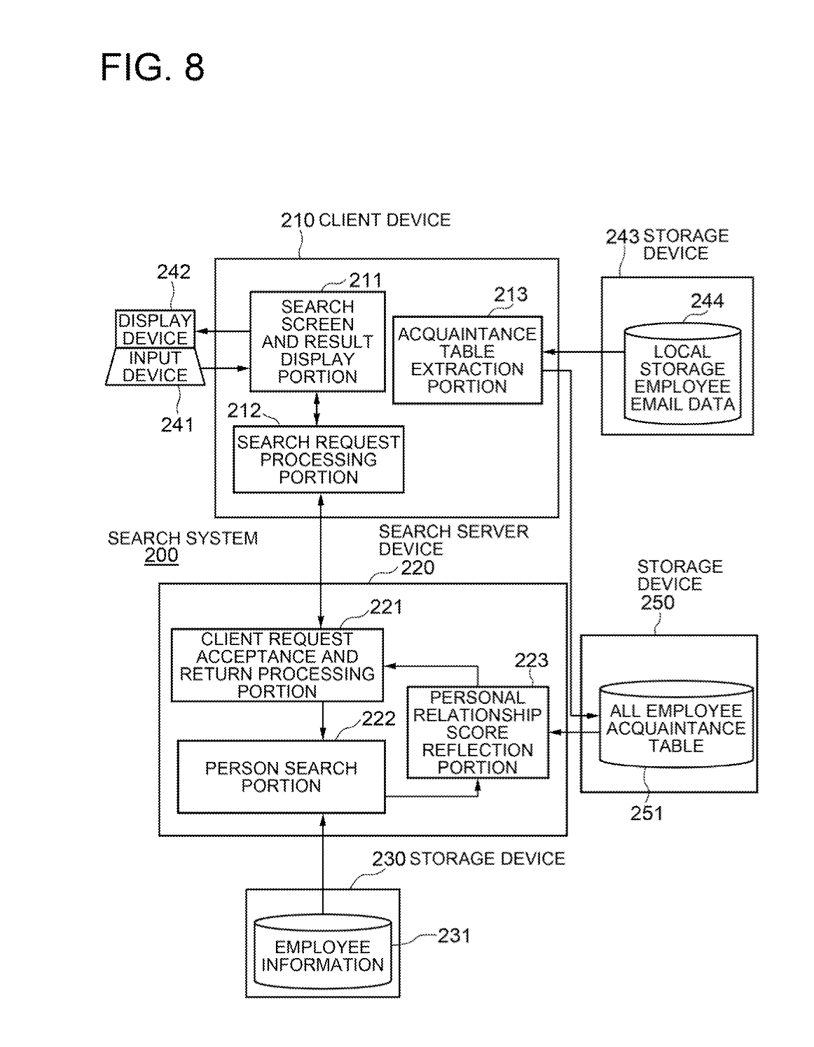

In reference to FIG. 8, a search system 200 in accordance with a second embodiment of the present invention is an in-company search system for employees of a particular company to search for persons who have a desired knowledge from the employees of their own company, and configured to include a client device 210, and a search server device 220 in connection with the client device 210 through a communication network such as an in-company network and the like.

The client device 210 is an information processing device utilized by the employees such as a personal computer assigned to each of the employees of the company. Herein, the client device 210 is supposed to be utilized by an employee U1. In FIG. 8, only one client device 210 is shown; however, if there are totally n employees U1 to Un, then there are n client devices corresponding to each of the employees in a one-for-one manner.

The client device 210 includes a search screen and result display portion 211, a search request processing portion 212, and an acquaintance table extraction portion 213. Further, an input device 241 configured by a keyboard, a mouse, and the like, a display device 242 configured by a liquid crystal display and the like, and a storage device 243 configured by a hard disk device and the like are connected to the client device 210. Further, the storage device 243 stores a local storage employee email data 244.

On the other hand, the search server device 220 includes a client request acceptance and return processing portion 221, a person search portion 222, and a personal relationship score reflection portion 223. Further, the search server device 220 is connected with a storage device 230 for storing employee information 231 and a storage device 250 for storing an all employee acquaintance table 251.

These members have such functions as described hereinbelow, respectively.

The local storage employee email data 244 is the same as the local storage employee email data 144 of FIG. 1 of the first exemplary embodiment.

The all employee acquaintance table 251 is an assembly of the individual acquaintance table of each employee created on the basis of the local storage employee email data 244 of each client device. Each individual acquaintance table in the assembly is the same as the individual acquaintance table 145 of FIG. 1 of the first exemplary embodiment, and has the same configuration such as that shown in FIG. 2.

The acquaintance table extraction portion 213 of the client device 210 is a unit for creating the individual acquaintance table for the use of the employee U1 of the client device 210 on the basis of the local storage employee email data 244 stored in the storage device 243 and storing it in the storage device 250. This acquaintance table extraction portion 213 is periodically started up. Although the startup frequency can be any, considering that to create the individual acquaintance table is a process which comparatively has a heavy load and takes a long time, and the calculation result does not change significantly in the case of a small number of newly added emails which have been sent and received, such a frequency is suitable as is started up once a week in the night.

The search screen and result display portion 211 of the client device 210 is a unit for displaying a search screen accepting a search request designating a search condition and the email address of the search requester, and a search result including the information of the employees who meet the search condition on the display device 242. The search screen and result display portion 211 transmits the search request accepted by the search screen to the search request processing portion 212, receives the search result in answer thereto from the search request processing portion 212, and outputs it to the display device 242.

The search request processing portion 212 receives the search request from the search screen and result display portion 211, transmits it to the search server device 220, receives the search result in answer thereto from the search server device 220, and outputs it to the search screen and result display portion 211. The search result received from the search server device 220 includes the email address of each employee who meets the search condition.

The employee information 231 is the same as the employee information 131 of FIG. 1 of the first exemplary embodiment.

The client request acceptance and return processing portion 221 of the search server device 220 receives the search request from the search request processing portion 212 of the client device 210 and outputs it to the person search portion 222, and receives the search result from the personal relationship score reflection portion 223 and returns it to the search request processing portion 212 of the client device 210.

The person search portion 222 receives the search request from the client request acceptance and return processing portion 221, searches the employee information 231 for persons who meet the search condition designated by the search request, and outputs the search result to the personal relationship score reflection portion 223.

The personal relationship score reflection portion 223 receives the search result from the person search portion 222, assigns the value of the acquainted degree with the search requester recorded in the individual acquaintance table to the employees included in the search result, and outputs the search result with the employees sorted in descending order of the assigned values of the acquainted degree to the client request acceptance and return processing portion 221.

Next, a behavior of the second exemplary embodiment will be explained.

First, an explanation will be made for a process of creating the all employee acquaintance table 251, which is periodically carried out.

When the acquaintance table extraction portion 213 of the client device 210 is started up, from the local storage employee email data 244, it extracts emails sent and received during a predetermined period in the past from the sent/received time and date recorded in the email header to the present time and date (for example, over the past one year) as the processing object emails, creates the individual acquaintance table for the use of the employee U1 of the subject client device 210 in the all employee acquaintance table 251 on the basis of the extracted processing object emails, relates it to the email address of the employee U1, and stores it in the storage device 250. The method for creating the individual acquaintance table is the same as by the acquaintance table extraction portion 113 in the first exemplary embodiment.

The acquaintance table extraction portion of other client devices also periodically creates the individual acquaintance table for the use of the employee of the respective subject client devices 210 in the all employee acquaintance table 251, relates it to the email address of the employee, and stores it in the storage device 250, respectively.

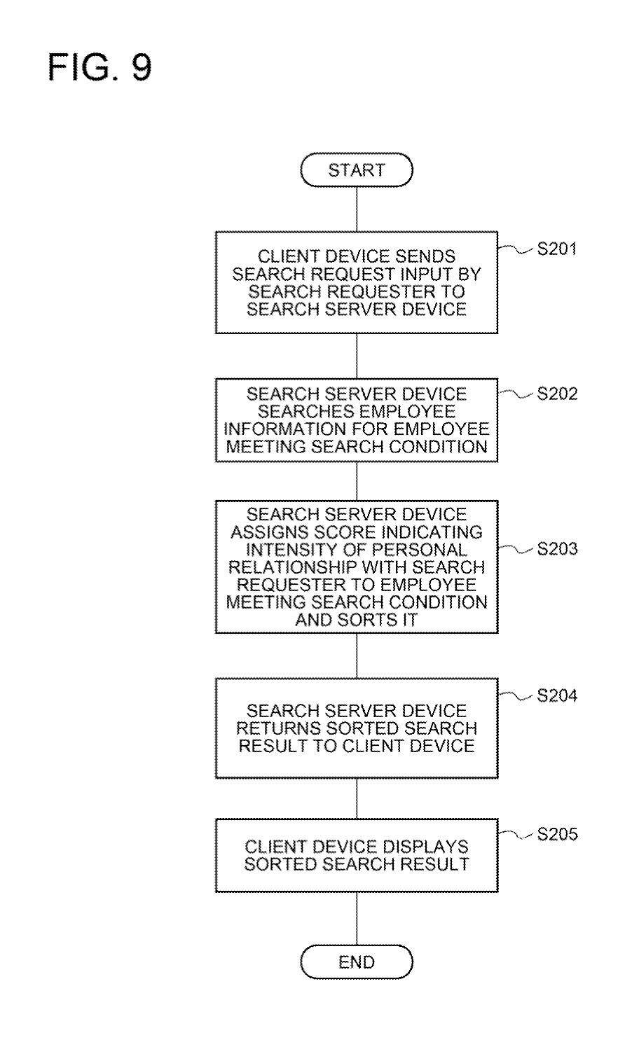

Subsequently, explanations will be made for a behavior at the time that the employee U1 of the client device 210 has inputted a search request designating a search condition in the second exemplary embodiment with reference to the flowchart of FIG. 9.

When a search request is inputted which designating a search condition with a search keyword and the email address of the search requester through the search screen which is displayed on the display device 242 by utilizing the search screen and result display portion 211, the client device 210 utilizes the search request processing portion 212 to transmit the search request to the search server device 220 (step S201).

On receiving the search request from the client device 210 by utilizing the client request acceptance and return processing portion 221, the search server device 220 utilizes the person search portion 222 to search the employee information 231 for employees who have a character string according with the search keyword designated by the search request as the search condition in the attribute information and acquire a search result (step S202). The search result includes the email address of the search requester and the meta-information including the email address of the employees searched out.

Next, the search server device 220 utilizes the personal relationship score reflection portion 223 to reflect a personal relationship score to the search result (step S203). In particular, the personal relationship score reflection portion 223 carries out the following process for each employee included in the search result.

First, from the all employee acquaintance table 251, the personal relationship score reflection portion 223 reads out the individual acquaintance table related to the email address of the search requester (the individual acquaintance table for the use of the employee U1 of the client device 210) as a search object table. Next, it searches the read-out search object table for the entry having the email address of the employee searched out in the acquaintance email address field. If the search is successful, it assigns the acquainted degree set in the acquainted degree field of the entry searched out to the employee as the first score. If the search is unsuccessful, it assigns the value 0 to the employee as the first score.

Next, from the all employee acquaintance table 251, the personal relationship score reflection portion 223 reads out all the individual acquaintance tables for the use of the acquaintances whose acquainted degree is not 0 in the individual acquaintance table for the use of the employee U1 of the client device 210 who is the search requester as search object tables. Next, setting the initial value of the second score at 0, the following process is repeatedly carried out for each search object table read out. First, the personal relationship score reflection portion 223 searches the search object table for the entry having the email address of the employee searched out in the acquaintance address field. Then, if the search is successful, it adds the acquainted degree set in the acquainted degree field of the entry searched out to the second score. Further, when the search object table successful in the search is the individual acquaintance table for the use of an employee Ux, it extracts the employee Ux as an inter-agent for the search requester to contact the employee searched out. On the other hand, if the search is unsuccessful, the personal relationship score reflection portion 223 does not add any value to the second score. Finally, it assigns the second score to the employee searched out after the process is finished for all the search object tables.

Next, the personal relationship score reflection portion 223 assigns different weights to the first score and the second score respectively, calculates the value by adding up these two weighted scores as a score indicating an intensity of the personal relationship between the employee searched out and the search requester, and assigns it to the employee searched out. Because the first score is a direct acquainted degree with the search requester while the second score is an acquainted degree of an acquaintance's acquaintance with the search requester, it is desirable to make the weight of the second score lighter than that of the first score; for example, to make the weight of the second score half of that of the first score.

Next, the personal relationship score reflection portion 223 removes the employees whose assigned score indicating the intensity of personal relationship is 0 from the search result. Next, it sorts the employees of the search result in descending order of the assigned scores indicating the intensity of personal relationship, and transmits the sorted search result to the client request acceptance and return processing portion 221. Further, the personal relationship score reflection portion 223 adds the score and its breakdown (the values of the first and second scores), and information of the inter-agent if extracted (for example, the name and email address) to the employees of the search result.

The search server device 220 utilizes the client request acceptance and return processing portion 221 to return the sorted search result to the client device 210 (step S204).

On receiving the search result from the search server device 220 by utilizing the search request processing portion 212, the client device 210 utilizes the search screen and result display portion 211 to display the search result on the display device 242 (step S205).

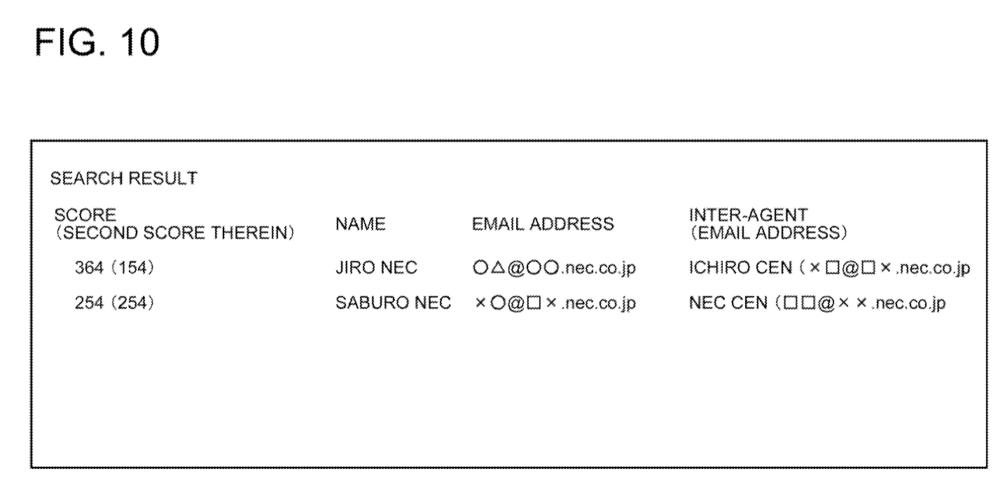

FIG. 10 shows an example of the search result displayed on the display device 242. As shown in FIG. 10, in the second exemplary embodiment, the information of the employees who meet the search condition is displayed in descending order of the scores. In the example, as the information of the employees, the score including its breakdown, the name, the email address, and the name and email address of the inter-agent are utilized. However, other information such as the telephone number and the like may also be displayed, or the score and its breakdown may also be omitted from the display.

In this manner, according to the second exemplary embodiment, because the employees who meet the search condition are displayed in descending order of the values of the score indicating the intensity of personal relationship with the search requester, it is possible for the search requester to instantly recognize from the search result who is easy to contact among the persons searched out.

Further, according to the second exemplary embodiment, it is possible to get hold of not only the personal relationship of having directly sent and received emails to and from the search requester but also the personal relationship of having directly sent and received emails to and from an employee who has directly sent and received emails to and from the search requester, in other words, still possible to get hold of the personal relationship with an acquaintance's acquaintance. Thereby, it is possible to contact the employees with whom there were no means for making contact in the first exemplary embodiment which only gets hold of direct acquaintances as the personal relationship, by means of introduction through a direct acquaintance of the search requester. Therefore, it is possible to contact more employees.

Further, according to the second exemplary embodiment, because the all employee acquaintance table 251 is created by each individual client device 210 in a shared and divided manner, in comparison with the configuration of creating the all employee acquaintance table 251 at one place, it is possible not only to avoid concentration of the load but also to improve the creation processing speed. Further, supposing a client device stops operation, and thus update of the personal relationship with the employee of that client device is stopped. However, because the information of personal relationship for all employees is created in the all employee acquaintance table 251, it is possible to continue the search service utilizing the personal relationship, thereby improving the reliability of the search system.

### A Third Exemplary Embodiment

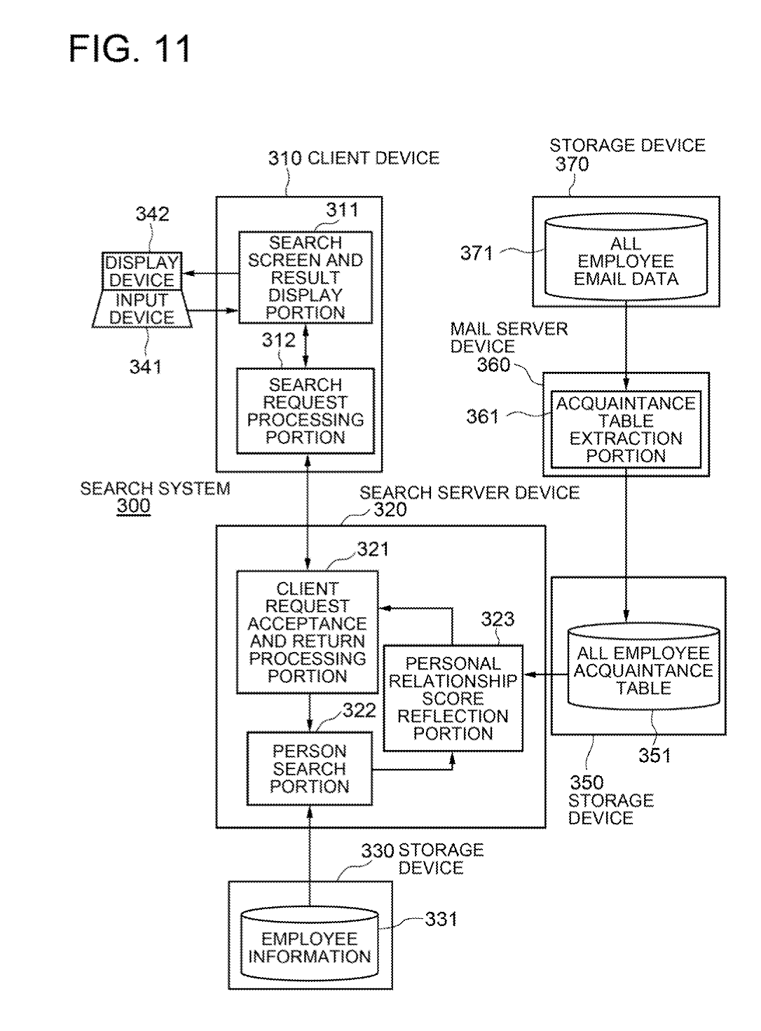

In reference to FIG. 11, a search system 300 in accordance with a third embodiment of the present invention is an in-company search system for employees of a particular company to search for persons who have a desired knowledge from the employees of their own company, and configured to include a client device 310, a search server device 320 in connection with the client device 310 through a communication network such as an in-company network and the like, and a mail server device 360 which is an in-company mail server.

The client device 310 is an information processing device utilized by the employees such as a personal computer assigned to each of the employees of the company. Herein, the client device 310 is supposed to be utilized by an employee U1. In FIG. 11, only one client device 310 is shown; however, if there are totally n employees U1 to Un, then there are n client devices corresponding to each of the employees in a one-for-one manner.

The client device 310 includes a search screen and result display portion 311, and a search request processing portion 312. Further, an input device 341 configured by a keyboard, a mouse, and the like, and a display device 342 configured by a liquid crystal display and the like are connected to the client device 310.

On the other hand, the search server device 320 includes a client request acceptance and return processing portion 321, a person search portion 322, and a personal relationship score reflection portion 323. Further, the search server device 320 is connected with a storage device 330 for storing employee information 331 and a storage device 350 for storing an all employee acquaintance table 351.

Further, the mail server device 360 includes an acquaintance table extraction portion 361. Further, the mail server device 360 is connected with a storage device 370 for storing an all employee email data 371.

These members have such functions as described hereinbelow, respectively.

The all employee email data 371 is a history of the emails sent and received by all the client devices 310, and corresponds to the information collected from the local storage employee email data 144 of FIG. 1 of the first exemplary embodiment with respect to all employees.

The all employee acquaintance table 351 is an assembly of the individual acquaintance table of each employee created on the basis of the all employee email data 371. Each individual acquaintance table in the assembly is the same as the individual acquaintance table 145 of FIG. 1 of the first exemplary embodiment, and has the same configuration such as that shown in FIG. 2.

The acquaintance table extraction portion 361 of the mail server device 360 is a unit for creating the all employee acquaintance table 351 on the basis of the all employee email data 371 and storing it in the storage device 350. This acquaintance table extraction portion 361 is periodically started up. Although the startup frequency can be any, considering that to create the all employee acquaintance table 351 is a process which comparatively has a heavy load and takes a long time, and the calculation result does not change significantly in the case of a small number of newly added emails which have been sent and received, such a frequency is suitable as is started up once a week in the night.

The search screen and result display portion 311 and the search request processing portion 312 of the client device 310 are the same as the search screen and result display portion 211 and the search request processing portion 212 shown in FIG. 8 of the second exemplary embodiment.

The employee information 331 is the same as the employee information 231 of FIG. 8 of the second exemplary embodiment.

The client request acceptance and return processing portion 321, the person search portion 322, and the personal relationship score reflection portion 323 of the search server device 320 are the same as the client request acceptance and return processing portion 221, the person search portion 222, and the personal relationship score reflection portion 223 of FIG. 8 of the second exemplary embodiment.

Next, a behavior of the third exemplary embodiment will be explained.

First, an explanation will be made for a process of creating the all employee acquaintance table 351, which is periodically carried out.

When the acquaintance table extraction portion 361 of the mail server device 360 is started up, from the all employee email data 371, it extracts the emails sent and received during a predetermined period in the past from the sent/received time and date recorded in the email header to the present time and date (for example, over the past one year) as the processing object emails, creates an individual acquaintance table for the use of the employee of each client device 310 in the all employee acquaintance table 351 on the basis of the extracted processing object emails, relates it to the email address of each employee, and stores it in the storage device 350. The method for creating each individual acquaintance table is the same as by the acquaintance table extraction portion 213 in the second exemplary embodiment.

In the third exemplary embodiment, the behavior at the time that the employee U1 of the client device 310 has inputted a search request designating a search condition is the same as has been explained in the second exemplary embodiment with reference to the flowchart of FIG. 9.

In this manner, according to the third exemplary embodiment, because the employees who meet the search condition are displayed in descending order of the values of the score indicating the intensity of personal relationship with the search requester, it is possible for the search requester to instantly recognize from the search result who is easy to contact among the persons searched out.

Further, according to the third exemplary embodiment, it is possible to get hold of not only the personal relationship of having directly sent and received emails to and from the search requester but also the personal relationship of having directly sent and received emails to and from an employee who has directly sent and received emails to and from the search requester, in other words, still possible to get hold of the personal relationship with an acquaintance's acquaintance. Thereby, it is possible to contact the employees with whom there were no means for making contact in the first exemplary embodiment which only gets hold of direct acquaintances as the personal relationship, by means of introduction through a direct acquaintance of the search requester. Therefore, it is possible to contact more employees.

Further, according to the third exemplary embodiment, because the mail server device 360 creates the all employee acquaintance table 351, it is possible to unify management of the all employee acquaintance table 351, thereby facilitating an easy operation. Further, it is not necessary at all to reconfigure the client device 310.

Hereinabove, the explanations were made with respect to the exemplary embodiments of the present invention. However, the present invention is not limited to the above exemplary embodiments only, but able to apply various additional modifications thereto as described hereinbelow.

In the second and third exemplary embodiments, both of the first and second scores are utilized to calculate the score indicating the intensity of personal relationship. However, in the same manner as the first exemplary embodiment, the score indicating the intensity of personal relationship may also be calculated from the first score only, and then assigned to the employees searched out.

Further, in each of the exemplary embodiments described hereinabove, the present invention is applied to an in-company search system for an employee of a particular company to search for persons who have a desired knowledge from the employees of the company. However, it is possible to apply the present invention to a search system for an individual of a particular group such as a particular business group, a particular circle, a particular organization, a particular association, and the like to search for persons who meet a desired search condition from the group.

Further, it is possible to accomplish each functional unit of the client device, the search server device, and the mail server device which constitute the present invention by means of a computer and a computer program other than hardware only.

[Supplementary Notes]

The whole or part of the exemplary embodiments disclosed hereinabove can be described as, but not limited to, the following supplementary notes.

(Supplementary Note 1)

A search system composed of a client device and a search server device for searching for a person who meets a search condition included in a search request received from the client device, the search system comprising:

a table for storing an acquainted degree between persons calculated on the basis of a history of sending and receiving emails sent and received between the persons; and

a personal relationship score reflection unit for assigning a score indicating an intensity of a personal relationship with a person who has inputted the search request to the person who has been searched out on the basis of the acquainted degree stored in the table, and sorting a search result in descending order of the score.

(Supplementary Note 2)

The search system according to Supplementary Note 1 further comprising a table extraction unit for calculating the acquainted degree between the persons on the basis of the history of sending and receiving emails sent and received between the persons so as to create the table.

(Supplementary Note 3)

The search system according to Supplementary Note 2, wherein the table extraction unit calculates the acquainted degree between the persons by utilizing one or two or three or all of a To number which is a total number of emails sent and received by address To, a Cc number which is a total number of emails sent and received by address Cc, a Reply number which is a total number of emails replied, and an email chain average number which is an average value of a replied number of groups of emails related by reply.

(Supplementary Note 4)

The search system according to Supplementary Note 3, wherein with respect to an email by a mailing list, the table extraction unit does not count the To number, the Cc number, the Reply number, and the email chain average number.

(Supplementary Note 5)

The search system according to Supplementary Note 3, wherein with respect to an email by a mailing list, the table extraction unit counts the To number, the Cc number, the Reply number, and the email chain average number for all members of the mailing list.

(Supplementary Note 6)

The search system according to Supplementary Note 3, wherein with respect to an email by a mailing list, the table extraction unit counts the To number, the Cc number, the Reply number, and the email chain average number only for a person who has later replied to the email by the mailing list among members of the mailing list.

(Supplementary Note 7)

The search system according to Supplementary Note 1, wherein the table is configured by an assembly of acquaintance tables for the use of an individual to store a score indicating an intensity of a personal relationship between a particular person and another person.

(Supplementary Note 8)

The search system according to Supplementary Note 7, wherein each of the acquaintance tables for the use of an individual is stored in a storage device able to be accessed from a client device utilized by the individual; and the personal relationship score reflection unit is provided in each client device.

(Supplementary Note 9)

The search system according to Supplementary Note 8, wherein the client device comprises a table extraction unit for calculating an acquainted degree between a person who utilizes the client device and another person on the basis of a history of sending and receiving emails sent and received between the person who utilizes the client device and the other person so as to create the acquaintance table for the use of the individual to utilize with the client device.

(Supplementary Note 10)

The search system according to Supplementary Note 7, wherein all the acquaintance tables for the use of an individual are stored in a storage device able to be accessed from the search server; and the personal relationship score reflection unit is provided in the search server.

(Supplementary Note 11)

The search system according to Supplementary Note 10, wherein the client device comprises a table extraction unit for calculating an acquainted degree between a person who utilizes the client device and another person on the basis of a history of sending and receiving emails sent and received between the person who utilizes the client device and the other person so as to create the acquaintance table for the use of the individual to utilize with the client device and store the same in the storage device able to be accessed from the search server.

(Supplementary Note 12)

The search system according to Supplementary Note 10 further comprising a mail server device which has a function of creating all the acquaintance tables for the use of an individual on the basis of a history of sending and receiving emails sent and received between all persons and storing the same in the storage device able to be accessed from the search server.

(Supplementary Note 13)

The search system according to Supplementary Note 1, wherein the personal relationship score reflection unit assigns a score indicating an intensity of a personal relationship between the person who has been searched out and a person who has inputted the search request on the basis of the acquainted degree between the person who has been searched out and the person who has inputted the search request.

(Supplementary Note 14)

The search system according to Supplementary Note 1, wherein the personal relationship score reflection unit assigns a score indicating an intensity of a personal relationship between the person who has been searched out and a person who has inputted the search request on the basis of the acquainted degree between the person who has been searched out and the person who has inputted the search request, and an acquainted degree between the person who has been searched out and a person who has a nonzero acquainted degree with the person who has inputted the search request.

(Supplementary Note 15)

The search system according to Supplementary Note 14, wherein the personal relationship score reflection unit calculates the score indicating the intensity of the personal relationship between the person who has been searched out and the person who has inputted the search request after assigning different weights respectively to the acquainted degree between the person who has been searched out and the person who has inputted the search request, and to the acquainted degree between the person who has been searched out and the person who has the nonzero acquainted degree with the person who has inputted the search request.

(Supplementary Note 16)

The search system according to Supplementary Note 14 or 15 further comprising a search result display unit for exhibiting information of a person who has a nonzero acquainted degree with the person searched out among the persons who have the nonzero acquainted degree with the person who has inputted the search request in relation to information of the person searched out in displaying a search result including the information of the person searched out.

(Supplementary Note 17)

A search method comprising the steps of:

transmitting a search request to a search server device by a client device;

searching for a person who meets a search condition included in the search request inputted from the client device by the search server device; and

assigning a score indicating an intensity of a personal relationship with a person who has inputted the search request to the person who has been searched out on the basis of an acquainted degree stored in a table for storing the acquainted degree between persons calculated on the basis of a history of sending and receiving emails sent and received between the persons so as to sort a search result in descending order of the score by any of the search server device and the client device.

(Supplementary Note 18)

The search method according to Supplementary Note 17 further comprising calculating the acquainted degree between the persons on the basis of the history of sending and receiving emails sent and received between the persons so as to create the table by a table extraction unit provided in any of the search server device and the client device.

(Supplementary Note 19)

The search method according to Supplementary Note 18, wherein the table extraction unit calculates the acquainted degree between the persons by utilizing one or two or three or all of a To number which is a total number of emails sent and received by address To, a Cc number which is a total number of emails sent and received by address Cc, a Reply number which is a total number of emails replied, and an email chain average number which is an average value of a replied number of groups of emails related by reply.

(Supplementary Note 20)

A client device comprising:

a search request processing unit transmitting a search request to a search server device, and receiving from the search server device a search result of searching for a person who meets a search condition included in the search request;

a table for storing an acquainted degree between persons calculated on the basis of a history of sending and receiving emails sent and received between the persons; and

a personal relationship score reflection unit for assigning a score indicating an intensity of a personal relationship with a person who has inputted the search request to the person who has been searched out on the basis of the acquainted degree stored in the table, and sorting the search result in descending order of the score.

(Supplementary Note 21)

The client device according to Supplementary Note 20 further comprising a table extraction unit for calculating the acquainted degree between the persons on the basis of the history of sending and receiving emails sent and received between the persons so as to create the table.

(Supplementary Note 22)

The client device according to Supplementary Note 21, wherein the table extraction unit calculates the acquainted degree between the persons by utilizing one or two or three or all of a To number which is a total number of emails sent and received by address To, a Cc number which is a total number of emails sent and received by address Cc, a Reply number which is a total number of emails replied, and an email chain average number which is an average value of a replied number of groups of emails related by reply.

(Supplementary Note 23)

A search server device having a function of searching for a person who meets a search condition included in a search request inputted from a client device, the search server device comprising:

a table for storing an acquainted degree between persons calculated on the basis of a history of sending and receiving emails sent and received between the persons; and

a personal relationship score reflection unit for assigning a score indicating an intensity of a personal relationship with a person who has inputted the search request to the person who has been searched out on the basis of the acquainted degree stored in the table, and sorting a search result in descending order of the score.

(Supplementary Note 24)

A computer program product comprising computer implementable instructions to make a computer which transmits a search request to a search server device and receives from the search server device a search result of searching for a person who meets a search condition included in the search request, function as:

a personal relationship score reflection unit for assigning a score indicating an intensity of a personal relationship with a person who has inputted the search request to the person who has been searched out on the basis, of an acquainted degree stored in a table for storing the acquainted degree between persons calculated on the basis of a history of sending and receiving emails sent and received between the persons; and sorting the search result in descending order of the score.

(Supplementary Note 25)

A computer program product comprising computer implementable instructions to make a computer which has a function of searching for a person who meets a search condition included in a search request inputted from a client device, function as:

a personal relationship score reflection unit for assigning a score indicating an intensity of a personal relationship with a person who has inputted the search request to the person who has been searched out on the basis of an acquainted degree stored in a table for storing the acquainted degree between persons calculated on the basis of a history of sending and receiving emails sent and received between the persons; and sorting a search result in descending order of the score.

(Supplementary Note 26)

A search method executed by a computer having an individual acquaintance table for storing an acquainted degree between a first person and another person calculated on the basis of a history of sending and receiving emails sent and received between the first person and the other person, the search method comprising the steps of

inputting a search request including a search condition;

transmitting the search request to a search server device, and receiving from the search server device a search result of searching for a person who meets the search condition;

assigning a score indicating an intensity of a personal relationship with the first person to the person included in the search result on the basis of the acquainted degree stored in the individual acquaintance table, and sorting the search result in descending order of the score; and

outputting the search result.

(Supplementary Note 27)

The search method according to Supplementary Note 26 further comprising updating the individual acquaintance table by calculating the acquainted degree between the first person and the other person on the basis of the history of sending and receiving emails sent and received between the first person and the other person during a certain period of time in the past.

(Supplementary Note 28)

The search method according to Supplementary Note 27, wherein in updating the individual acquaintance table, the acquainted degree between the persons is calculated by utilizing one or two or three or all of a To number which is a total number of emails sent and received by address To, a Cc number which is a total number of emails sent and received by address Cc, a Reply number which is a total number of emails replied, and an email chain average number which is an average value of a replied number of groups of emails related by reply.

(Supplementary Note 29)

The search method according to Supplementary Note 28, wherein in updating the individual acquaintance table, with respect to an email by a mailing list, the To number, the Cc number, the Reply number, and the email chain average number are not counted.

(Supplementary Note 30)

The search method according to Supplementary Note 28, wherein in updating the individual acquaintance table, with respect to an email by a mailing list, the To number, the Cc number, the Reply number, and the email chain average number are counted for all members of the mailing list.

(Supplementary Note 31)

The search method according to Supplementary Note 28, wherein in updating the individual acquaintance table, with respect to an email by a mailing list, the To number, the Cc number, the Reply number, and the email chain average number are counted only for a person who has later replied to the email by the mailing list among members of the mailing list.

(Supplementary Note 32)

A search method executed by a computer having a plurality of individual acquaintance tables for storing an acquainted degree between a person and another person calculated on the basis of a history of sending and receiving emails sent and received between the person and the other person in correspondence with each person, the search method comprising the steps of:

receiving a search request including information of a search requester and a search condition from a client device;

creating a search result by searching for a person who meets the search condition;

assigning a score indicating an intensity of a personal relationship with the search requester to the person included in the search result on the basis of the acquainted degree stored in the individual acquaintance table specified with the information of the search requester among the plurality of individual acquaintance tables, and sorting the search result in descending order of the score; and

transmitting the search result to the client device.

(Supplementary Note 33)

A search system provided with a search server device having a function of searching for a person who meets a search condition included in a search request inputted from a client device, the search system comprising:

a table for storing an acquainted degree between persons calculated on the basis of a history of sending and receiving emails sent and received between the persons; and

a personal relationship score reflection means for assigning a score indicating an intensity of a personal relationship with a person who has inputted the search request to the person who has been searched out on the basis of the acquainted degree stored in the table, and sorting a search result in descending order of the score.

1. A search system composed of a client device and a search server device for searching for a person who meets a search condition included in a search request received from the client device, the search system comprising:
a table for storing an acquainted degree between persons calculated on the basis of a history of sending and receiving emails sent and received between the persons; and
a personal relationship score reflection unit for assigning a score indicating an intensity of a personal relationship with a person who has inputted the search request to the person who has been searched out on the basis of the acquainted degree stored in the table, and sorting a search result in descending order of the score.

2. The search system according to claim 1 further comprising a table extraction unit for calculating the acquainted degree between the persons on the basis of the history of sending and receiving emails sent and received between the persons so as to create the table.

3. The search system according to claim 2, wherein the table extraction unit calculates the acquainted degree between the persons by utilizing one or two or three or all of a To number which is a total number of emails sent and received by address To, a Cc number which is a total number of emails sent and received by address Cc, a Reply number which is a total number of emails replied, and an email chain average number which is an average value of a replied number of groups of emails related by reply.

4. The search system according to claim 3, wherein with respect to an email by a mailing list, the table extraction unit does not count the To number, the Cc number, the Reply number, and the email chain average number.

5. The search system according to claim 3, wherein with respect to an email by a mailing list, the table extraction unit counts the To number, the Cc number, the Reply number, and the email chain average number for all members of the mailing list.

6. The search system according to claim 3, wherein with respect to an email by a mailing list, the table extraction unit counts the To number, the Cc number, the Reply number, and the email chain average number only for a person who has later replied to the email by the mailing list among members of the mailing list.

7. The search system according to claim 1, wherein the table is configured by an assembly of acquaintance tables for the use of an individual to store a score indicating an intensity of a personal relationship between a particular person and another person.

8. The search system according to claim 7, wherein each of the acquaintance tables for the use of an individual is stored in a storage device able to be accessed from a client device utilized by the individual; and the personal relationship score reflection unit is provided in each client device.

9. The search system according to claim 8, wherein the client device comprises a table extraction unit for calculating an acquainted degree between a person who utilizes the client device and another person on the basis of a history of sending and receiving emails sent and received between the person who utilizes the client device and the other person so as to create the acquaintance table for the use of the individual to utilize with the client device.

10. The search system according to claim 7, wherein all the acquaintance tables for the use of an individual are stored in a storage device able to be accessed from the search server; and the personal relationship score reflection unit is provided in the search server.

11. The search system according to claim 10, wherein the client device comprises a table extraction unit for calculating an acquainted degree between a person who utilizes the client device and another person on the basis of a history of sending and receiving emails sent and received between the person who utilizes the client device and the other person so as to create the acquaintance table for the use of the individual to utilize with the client device and store the same in the storage device able to be accessed from the search server.

12. The search system according to claim 10 further comprising a mail server device which has a function of creating all the acquaintance tables for the use of an individual on the basis of a history of sending and receiving emails sent and received between all persons and storing the same in the storage device able to be accessed from the search server.

13. The search system according to claim 1, wherein the personal relationship score reflection unit assigns a score indicating an intensity of a personal relationship between the person who has been searched out and a person who has inputted the search request on the basis of the acquainted degree between the person who has been searched out and the person who has inputted the search request.

14. The search system according to claim 1, wherein the personal relationship score reflection unit assigns a score indicating an intensity of a personal relationship between the person who has been searched out and a person who has inputted the search request on the basis of the acquainted degree between the person who has been searched out and the person who has inputted the search request, and an acquainted degree between the person who has been searched out and a person who has a nonzero acquainted degree with the person who has inputted the search request.

15. The search system according to claim 14, wherein the personal relationship score reflection unit calculates the score indicating the intensity of the personal relationship between the person who has been searched out and the person who has inputted the search request after assigning different weights respectively to the acquainted degree between the person who has been searched out and the person who has inputted the search request, and to the acquainted degree between the person who has been searched out and the person who has the nonzero acquainted degree with the person who has inputted the search request.

16. The search system according to claim 14 further comprising a search result display unit for exhibiting information of a person who has a nonzero acquainted degree with the person searched out among the persons who have the nonzero acquainted degree with the person who has inputted the search request in relation to information of the person searched out in displaying a search result including the information of the person searched out.

17. A client device comprising:
a search request processing unit transmitting a search request to a search server device, and receiving from the search server device a search result of searching for a person who meets a search condition included in the search request;
a table for storing an acquainted degree between persons calculated on the basis of a history of sending and receiving emails sent and received between the persons; and
a personal relationship score reflection unit for assigning a score indicating an intensity of a personal relationship with a person who has inputted the search request to the person who has been searched out on the basis of the acquainted degree stored in the table, and sorting the search result in descending order of the score.

18. The client device according to claim 17 further comprising a table extraction unit for calculating the acquainted degree between the persons on the basis of the history of sending and receiving emails sent and received between the persons so as to create the table.

19. The client device according to claim 18, wherein the table extraction unit calculates the acquainted degree between the persons by utilizing one or two or three or all of a To number which is a total number of emails sent and received by address To, a Cc number which is a total number of emails sent and received by address Cc, a Reply number which is a total number of emails replied, and an email chain average number which is an average value of a replied number of groups of emails related by reply.

20. A search method executed by a computer having a plurality of individual acquaintance tables for storing an acquainted degree between a person and another person calculated on the basis of a history of sending and receiving emails sent and received between the person and the other person in correspondence with each person, the search method comprising the steps of:
receiving a search request including information of a search requester and a search condition from a client device;
creating a search result by searching for a person who meets the search condition;
assigning a score indicating an intensity of a personal relationship with the search requester to the person included in the search result on the basis of the acquainted degree stored in the individual acquaintance table specified with the information of the search requester among the plurality of individual acquaintance tables, and sorting the search result in descending order of the score; and
transmitting the search result to the client device.
